(19) United States
(12) Patent Application Publication
(10) Pub. No.: US 2026/0267388 A1
(43) Pub. Date: Sep. 10, 2026

(54) SYSTEM FOR ROW-COLUMN SCANNING CONTROL BASED ON SLEEP AND WAKE-UP FUNCTION CHIP

(71) Applicant: SEMIMENT TECHNOLOGY CO., LTD., Shanghai (CN)

(72) Inventors: Lichao LI, Shanghai (CN); Chao ZHANG, Shanghai (CN)

(73) Assignee: SEMIMENT TECHNOLOGY CO., LTD., Shanghai (CN)

(21) Appl. No.: 19/537,445

(22) Filed: Feb. 11, 2026

Related U.S. Application Data
(63) Continuation of application No. PCT/CN2025/116305, filed on Aug. 22, 2025.

(30) Foreign Application Priority Data
Mar. 5, 2025 (CN) 202510253258.0

(51) Int. Cl. G06F 1/3203; G06F 1/3287

(52) U.S. Cl. CPC G06F 1/3203; G06F 1/3287

(57) ABSTRACT

Provided is a system for row-column scanning control based on a sleep and wake-up function chip. The system comprises: a linear Hall chip matrix and a main control unit. Each of linear Hall chips includes: a sleep pin, a wake-up pin, and a signal output pin. The main control unit includes at least: M sets of acquisition input ports. The main control unit controls the system to enter a high-speed row-by-row scanning mode, a high-speed interlaced row scanning mode, or a medium-speed scanning mode by configuring a logic combination of the sleep pins and/or the wake-up pins, and receives detection signals output from the linear Hall chip matrix.

### CROSS-REFERENCE TO RELATED APPLICATIONS

This application is a Continuation of International Application No. PCT/CN2025/116305, filed on Aug. 22, 2025, which claims priority to Chinese Patent Application No. 202510253258.0, filed on Mar. 5, 2025, the entire contents of each of which are hereby incorporated by reference.

### TECHNICAL FIELD

The present disclosure generally relates to the field of electronic equipment, and in particular to a system for row-column scanning control based on a sleep and wake-up function chip.

### BACKGROUND

A linear Hall chip is a sensor chip widely used in industrial control and automotive electronics fields for detecting magnetic field variation and outputting a corresponding electrical signal. Traditional linear Hall chip control systems typically adopt a simple row-column scanning architecture. However, in large-scale chip matrices, the following technical problems exist: (1) High resource occupation: under the condition of limited microcontroller unit (MCU) pins, directly controlling row and column signals of a large-scale chip matrix leads to exhaustion of pin resources, limiting system scalability; (2) insufficient real-time performance: in the scenarios of high-speed signal acquisition, traditional systems have delays in row-column switching, making it difficult to meet requirements for high-precision and high-speed data acquisition; (3) weak anti-interference capability: in complex environments, signals are prone to superimposing high-frequency noise, affecting sampling accuracy of analog-to-digital converter (ADC) signals.

Therefore, it is desirable to provide a system for row-column scanning control based on a sleep and wake-up function chip, which can reduce resource occupation, improve signal acquisition real-time performance, and enhance signal anti-interference capability.

### SUMMARY

One or more embodiments of the present disclosure provide a system for row-column scanning control based on a sleep and wake-up function chip. The system comprises: a linear Hall chip matrix including a plurality of linear Hall chips arranged in a matrix structure of N rows × M columns, wherein each of the plurality of linear Hall chips includes: a sleep pin configured to receive a sleep signal to control an operation state of the linear Hall chip and switch the linear Hall chip to a sleep state; a wake-up pin configured to receive a logic control signal to manage an output state of the linear Hall chip, or output an interrupt signal in the sleep state to trigger system wake-up; and a signal output pin configured to output a detection signal; and a main control unit, wherein the main control unit is connected to the sleep pins and the wake-up pins of each row of the linear Hall chips; wherein the main control unit includes at least: M sets of acquisition input ports corresponding to M columns of the linear Hall chip matrix, respectively; the signal output pins of each column of the linear Hall chips are short-circuited and correspondingly connected to a set of acquisition input ports of the main control unit; the main control unit controls the system to enter a high-speed row-by-row scanning mode, a high-speed interlaced row scanning mode, or a medium-speed scanning mode by configuring a logic combination of the sleep pins and/or the wake-up pins, and receives the detection signal output by the linear Hall chip matrix. The system is operable in different scanning modes, and the operation state of the linear Hall chip matrix is controlled by the main control unit. In the high-speed row-by-row scanning mode, the main control unit activates linear Hall chips of a target row in sequence to enter the operation state for magnetic field detection, and linear Hall chips of remaining rows maintain the sleep state; when the linear Hall chips of the target row complete detection, the linear Hall chips of the target row re-enter the sleep state, and linear Hall chips of a next target row are activated, thereby achieving high-speed row-by-row scanning by cycling. In the high-speed interlaced row scanning mode, the main control unit simultaneously activates a plurality of rows of linear Hall chips based on a preset logic to synchronously enter the operation state; the main control unit acquires detection signals of a current target row in sequence, while the linear Hall chips of the next target row are already in a pending acquisition state, thereby achieving interlaced row high-speed scanning by cycling. In the medium-speed scanning mode, the main control unit controls the linear Hall chips of the target row to maintain the operation state, and the linear Hall chips of the remaining rows maintain the sleep state, thereby achieving medium-speed scanning by cycling. In the sleep state, if any of the linear Hall chips detects an external magnetic field variation, the interrupt signal is output to the main control unit through the wake-up pin to trigger system wake-up.

### BRIEF DESCRIPTION OF THE DRAWINGS

The present disclosure is further described by way of exemplary embodiments. The exemplary embodiments are described in detail with reference to the accompanying drawings. The embodiments are not limiting. In the embodiments, the same reference numerals denote the same structures, wherein:

FIG. 1 is a schematic structural diagram of a system for row-column scanning control based on a sleep and wake-up function chip according to some embodiments of the present disclosure;

FIG. 2 is a schematic structural diagram of a system for row-column scanning control based on a sleep and wake-up function chip according to some embodiments of the present disclosure;

FIG. 3 is a waveform diagram of a system for row-column scanning control based on a sleep and wake-up function chip in a high-speed row-by-row scanning mode according to some embodiments of the present disclosure;

FIG. 4 is a waveform diagram of a system for row-column scanning control based on a sleep and wake-up function chip in a high-speed interlaced row scanning mode according to some embodiments of the present disclosure;

FIG. 5 is a waveform diagram of a system for row-column scanning control based on a sleep and wake-up function chip in a medium-speed scanning mode according to some embodiments of the present disclosure;

FIG. 6 is a waveform diagram of a system for row-column scanning control based on a sleep and wake-up function chip in an interrupt wake-up mode according to some embodiments of the present disclosure;

FIG. 7 is a schematic structural diagram of a system for row-column scanning control based on a sleep and wake-up function chip according to some embodiments of the present disclosure.

### DETAILED DESCRIPTION

Exemplary embodiments will be described in detail herein, examples of which are illustrated in the accompanying drawings. When the following description refers to the accompanying drawings, unless otherwise indicated, the same numbers in different drawings represent the same or similar elements. The implementations described in the following exemplary embodiments do not represent all implementations consistent with the present disclosure. On the contrary, the implementations are merely examples of apparatuses consistent with some aspects of the present disclosure as detailed in the appended claims.

The terms used in the present disclosure are for the purpose of describing particular embodiments only and are not intended to limit the present disclosure. Unless otherwise defined, technical terms or scientific terms used in the present disclosure shall have the ordinary meanings as understood by those of ordinary skill in the art to which the present disclosure pertains. The terms “first”, “second”, or the like used in the present disclosure and the claims do not denote any order, quantity, or importance, but are merely used to distinguish different components. Similarly, the terms “a” or “an”, or the like, do not denote a quantity limitation, but denote the existence of at least one. When referring to only “one”, it will be separately stated. The terms “a plurality of” or “several” denote two or more. Unless otherwise indicated, terms such as “front”, “rear”, “lower”, and/or “upper” are merely for convenience of description and are not limited to one position or one spatial orientation. The terms “include” or “comprise”, or the like, mean that elements or items appearing before the terms “include” or “comprise” cover the elements or items listed after the terms and their equivalents, and do not exclude other elements or items. The terms “connect” or “couple”, or the like, are not limited to physical or mechanical connections, but may also include electrical connections, whether direct or indirect. The singular forms “a”, “the”, and “said” used in the present disclosure and the appended claims are also intended to include plural forms, unless the context clearly indicates otherwise. It should also be understood that the term “and/or” used herein refers to and encompasses any and all possible combinations of one or more of the associated listed items.

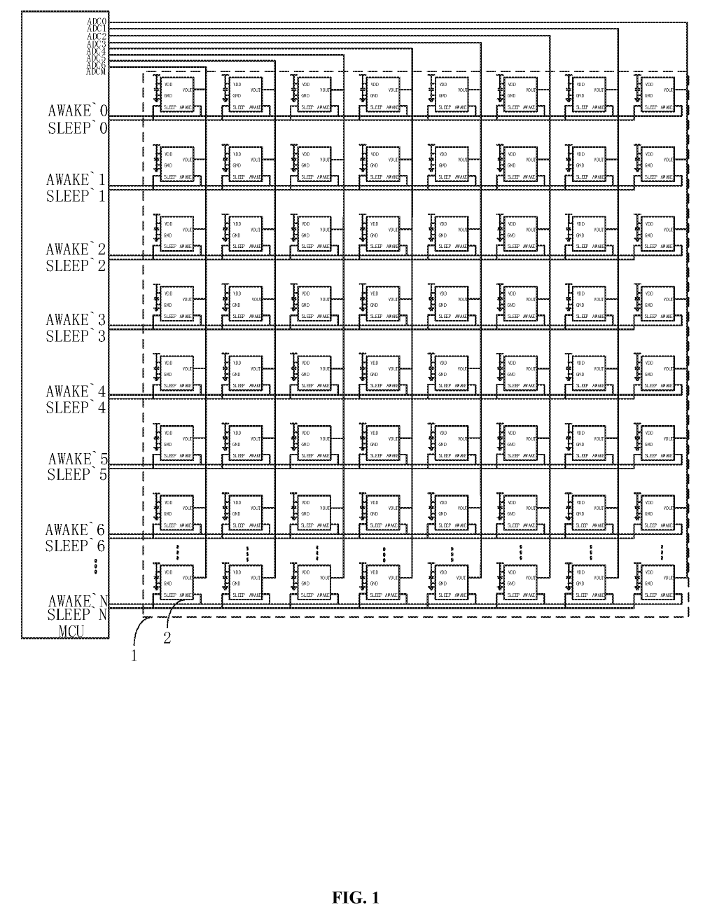

FIG. 1 is a schematic structural diagram of a system for row-column scanning control based on a sleep and wake-up function chip according to some embodiments of the present disclosure.

In some embodiments, as shown in FIG. 1, the present disclosure provides the system for row-column scanning control based on the sleep and wake-up function chip. The system includes: a linear Hall chip matrix 1 formed by arranging a plurality of linear Hall chips 2 in a matrix structure of N rows x M columns.

The linear Hall chip matrix 1 refers to a chip matrix formed by combining a plurality of linear Hall chips in an N x M matrix.

The linear Hall chips 2 refer to magnetic sensor integrated circuits based on the Hall effect.

In some embodiments, the linear Hall chips may continuously and linearly detect an external magnetic field variation and output an analog voltage or digital signal proportional to the external magnetic field variation.

In some embodiments, each of the linear Hall chips 2 may include a sleep pin SLEEP, a wake-up pin AWAKE, and a signal output pin OUT.

The sleep pin refers to a pin for switching the linear Hall chip to a sleep state.

In some embodiments, the sleep pin is configured to receive a sleep signal output by a main control chip, to enable the main control chip to control an operation state of the chip through the sleep pin. A main control unit may include the main control chip.

The sleep signal refers to a level control signal for switching the linear Hall chip to the sleep state.

In some embodiments, the sleep signal may be a high-level signal (e.g., 2.4 V-5 V).

The operation state refers to an operating state in which the linear Hall chip normally performs magnetic field detection and outputs a valid signal. The magnetic field detection refers to an operation of detecting an external magnetic field of the linear Hall chip.

The sleep state refers to a state in which the linear Hall chip enters a low power consumption standby mode.

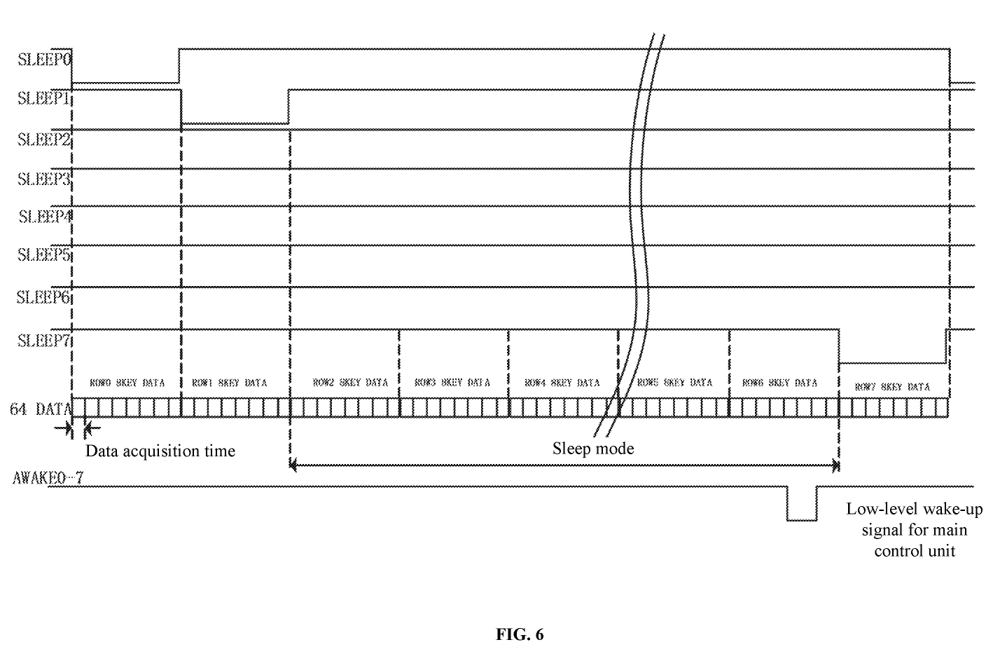

In some embodiments, the main control unit may control the linear Hall chip to switch between the operation state and the sleep state based on the sleep signal and an interrupt signal. More descriptions regarding how to switch states may be found in FIG. 6 and the related descriptions thereof.

The wake-up pin refers to a pin in the linear Hall chip for triggering system wake-up.

In some embodiments, the wake-up pin may be configured to receive a logic control signal.

The logic control signal refers to a signal for controlling an electrical state of the signal output pin.

In some embodiments, the logic control signal includes, but is not limited to, a level signal, a level inversion signal, a pulse signal, a timing control signal, or a data carrier signal.

In some embodiments, the wake-up pin may manage an output state of the signal output pin of the linear Hall chip, or output the interrupt signal to trigger system wake-up.

The output state refers to an electrical characteristic state of the signal output pin. For example, the output state may include an effective output state and a high-impedance state. The high-impedance state refers to a state where, in a non-gated state, the signal output pin of the linear Hall chip presents an extremely high resistance characteristic through internal circuit switching.

In some embodiments, the main control unit may configure a high-level signal to the wake-up pin to control the signal output pin in the linear Hall chip where the wake-up pin is located to present the effective output state, or configure a low-level signal to the wake-up pin to control the signal output pin in the linear Hall chip where the wake-up pin is located to present the high-impedance state. Herein, the high-level signal may be a signal with a voltage being in a range of 2.4 V to 5 V, and the low-level signal may be a signal with a voltage being in a range of 0 V to 0.8 V.

The interrupt signal refers to a wake-up request signal output to the main control unit. In some embodiments, the interrupt signal may be a low-level signal.

The system wake-up refers to a process of switching from a low power consumption sleep state to a normal operation state.

In some embodiments, the wake-up pin may output the interrupt signal to the main control unit to enable the main control unit to trigger the system wake-up from the sleep state to the operation state.

The external magnetic field variation refers to a variation in an external magnetic field intensity or direction of the linear Hall chip.

For example, the external magnetic field variation may include a magnetic field intensity variation, a magnetic field direction variation, or the like.

The signal output pin refers to a pin used for outputting a detection signal.

The detection signal refers to a valid data signal sent to the main control unit.

In some embodiments, the detection signal of the linear Hall chip supports analog voltage output or digital signal output to adapt to requirements of different data acquisition equipment.

The analog voltage output refers to a manner where the detection signal is output in the form of a continuous and variable direct current voltage signal.

For example, in a three-mode keyboard application, when a distance between a key magnet and the linear Hall chip decreases from 5 mm to 2 mm, a magnetic field intensity increases from 20 Gs to 180 Gs, and a voltage output by the detection signal increases from 0.5 V to 2.5 V.

The digital signal output refers to a manner of encoding a magnetic field intensity value into a discrete digital output.

The data acquisition equipment refers to equipment having capabilities of signal reception, analog-to-digital conversion, and data processing.

For example, the data acquisition equipment may include, but is not limited to, a microcontroller (MCU), a programmable logic controller (PLC), or a host computer (PC), etc.

In some embodiments of the present disclosure, the detection signal supports the analog voltage output or the digital signal output, which can seamlessly interface with different types of data acquisition equipment. There is no need to design two sets of hardware solutions for analog/digital requirements. Switching between output modes can be achieved merely through software configuration or pin selection, thereby reducing spare parts inventory and maintenance complexity.

In some embodiments, the sleep state: when the main control unit sends the sleep signal to linear Hall chips of a target row, the linear Hall chips of the target row enter the sleep state, stop normal signal output, and cause signal output pins of the linear Hall chips of the target row to be in the high-impedance state; the operation state: when the main control unit sends a wake-up signal to the linear Hall chips of the target row, the linear Hall chips of the target row exit the sleep state and enter the operation state, start detecting the external magnetic field variation, and sends the detection signals through corresponding signal output pins; the main control unit, by dynamically controlling the sleep pins and the wake-up pins of the linear Hall chips of each row, achieves row-by-row scanning, enabling the linear Hall chips of the target row to be in the operation state, while the linear Hall chips of remaining rows maintain the sleep state or the high-impedance state.

The target row refers to a currently selected row in the linear Hall chip matrix that requires control to be executed.

The normal signal refers to a signal in the detection signals that is in the effective output state.

In some embodiments, the main control unit configures a high-level signal to the sleep pin of the linear Hall chip, enabling the linear Hall chip to enter the sleep state, and turns off an internal power supply, enabling the signal output pin to present the high-impedance state and stop outputting of the normal signal.

The wake-up signal refers to a level control instruction sent to the wake-up pin.

In some embodiments, the logic control signal may include the wake-up signal.

In some embodiments, the main control unit may send the low-level signal to the sleep pins of the target row to release the sleep state, and send the high-level signal to the wake-up pins of the target row to enable the wake-up pins to perform signal output, thereby enabling the linear Hall chips of the target row to exit the sleep state and enter the operation state.

In some embodiments of the present disclosure, by dynamic configuration of the high/low level of the sleep pin, nanosecond-level switching between the operation state and the sleep state of the chip is achieved. Static power consumption of chips of non-target rows is reduced, ensuring that only chips of the target row on the same bus output valid signals. Leakage current of the chips of the non-target rows is small, avoiding signal superposition interference.

In some embodiments, the system for row-column scanning control further supports an interrupt wake-up mode. In a standby state, when the linear Hall chip detects the magnetic field variation, the main control unit may be triggered to wake up, achieving the combination of low-power-consumption operation and high response speed.

The interrupt wake-up mode refers to a detection state of low power consumption standby and event-triggered response.

In some embodiments, the main control unit configures all sleep pins in the linear Hall chip matrix to a low power consumption mode, enabling all the linear Hall chips to enter a low-frequency signal acquisition state, while the main control unit switches to the sleep state, retaining only an interrupt wake-up function. All the linear Hall chips detect the external magnetic field variation at a preset time interval. When the external magnetic field variation detected by any of the linear Hall chips exceeds a set threshold, the linear Hall chip outputs the interrupt signal to the main control unit. After receiving the interrupt signal, the main control unit switches from the sleep state to the operation state, reconfigures an operation logic of the linear Hall chip matrix, activates the linear Hall chips of the target row, and completes signal acquisition.

The interrupt wake-up function refers to a trigger driving mechanism for the main control unit to exit the sleep state in the low power consumption standby state.

The low power consumption mode refers to a standby detection state where total power consumption is reduced to a microampere level.

The low-frequency signal acquisition state refers to a state of intermittently sampling the external magnetic field at an extremely low sampling frequency (e.g., 10 Hz to 1 kHz) under low power consumption.

In some embodiments, in response to the main control unit sending the sleep signal to the linear Hall chip, the main control unit enters the low power consumption mode.

The set threshold refers to a parameter for determining whether to output an interrupt signal.

In some embodiments, the set threshold may be preset by a technician based on experience.

FIG. 6 is a waveform diagram of a system for row-column scanning control based on a sleep and wake-up function chip in an interrupt wake-up mode according to some embodiments of the present disclosure.

As shown in FIG. 6, in the interrupt wake-up mode, before all linear Hall chips enter a low-frequency signal acquisition state, the main control unit first configures all sleep ports as high-level outputs, configures all wake-up ports as interrupt wake-up input states, and enters the sleep state. At this time, all chips enter the low-frequency signal acquisition state and detect the external magnetic field variation at a preset time interval (e.g., detecting the external magnetic field variation once every 12.5 ms). Further, if any of the linear Hall chips detects that the external magnetic field variation exceeds a set threshold, the linear Hall chip switches the wake-up pin from a high level to a low level and outputs the low level to the main control unit, and the low-level output is the interrupt signal output. In response to receiving the interrupt signal, the main control unit is woken up, that is, switches from the sleep state to the operation state, and wakes up the entire system to resume operation. In this way, the overall power consumption of the system is reduced, the response speed of the system is improved, and the user experience is enhanced.

In some embodiments of the present disclosure, by the architectural innovation of system-side sleep plus event-triggered wake-up, breakthroughs of orders of magnitude are achieved in terms of power consumption, speed, cost, and reliability, thereby realizing improved response real-time performance of the system while reducing power consumption.

In some embodiments, the main control unit controls a plurality of linear Hall chip matrices through a clock signal to achieve synchronous signal acquisition.

The clock signal refers to a periodic synchronous pulse sequence sent to the linear Hall chip matrix or to rows within the linear Hall chip matrix.

It is understood that the clock signal is used to uniformly coordinate the sampling timing and state switching of each linear Hall chip matrix/row/column, ensuring delay-free synchronous sampling and phase consistency in cross-matrix or multi-channel applications.

In some embodiments, the main control unit may drive a shift register through the clock signal to switch the sleep and wake-up states of the linear Hall chip matrix row by row, achieving synchronous signal acquisition. More descriptions regarding the shift register may be found in the related descriptions below.

It is understood that the clock signal serves as a timing reference for row switching, triggering the shift register to update the output state at each clock edge, thereby sequentially enabling the linear Hall chips of the target row and disabling the linear Hall chips of the non-target rows, completing row-by-row scanning while ensuring electrical isolation of the column bus and avoiding any signal conflicts. Meanwhile, the clock signal may be synchronously distributed to the plurality of linear Hall chip matrices, maintaining a high degree of consistency in sampling moments of the linear Hall chip matrices, thereby achieving parallel data acquisition and collaborative operation across the matrices, which is suitable for large-scale multi-node application scenarios.

In some embodiments of the present disclosure, by introducing the clock signal for unified synchronous control of the plurality of linear Hall chip matrices, significant technological progress and performance optimization are achieved at the system architecture level. The clock signal, as a common timing reference source, ensures that the sampling actions of all matrices can be triggered at highly consistent moments, fundamentally eliminating the sampling time deviation introduced by the main control unit operating different matrices in a time-sharing manner.

In some embodiments, the linear Hall chip matrix may adopt a dynamic N x M arrangement, where N and M are any positive integers, to adapt to different signal acquisition requirements.

In some embodiments, the system for row-column scanning control based on the sleep and wake-up function chip provided in the present disclosure further includes a main control unit MCU.

The main control unit MCU refers to an external micro-control unit that performs dynamic row-column scanning management of the linear Hall chip matrix through electrical connection.

In some embodiments, the main control unit MCU is connected to the linear Hall chip matrix and configured to control switching of the operation state of the linear Hall chip matrix, row-column signal switching, target row activation, and signal acquisition by configuring a logic combination of the sleep pins and/or the wake-up pins. The logic combination refers to a multi-dimensional control instruction set formed by sending configurable level signals and timing relationships to the sleep pins and/or the wake-up pins.

In some embodiments, the logic combination includes, but is not limited to, high and low levels.

In some embodiments, the main control unit includes at least M sets of acquisition input ports.

In some embodiments, the M sets of acquisition input ports respectively correspond to M columns of the linear Hall chip matrix. The signal output pins of the linear Hall chips in each column are short-circuited and correspondingly connected to a set of acquisition input ports of the main control unit.

The acquisition input ports are electrical interfaces for receiving detection signals from each column of the linear Hall chip matrix.

In some embodiments, the main control unit controls the system to enter a high-speed row-by-row scanning mode, a high-speed interlaced row scanning mode, or a medium-speed scanning mode by configuring the logic combination of the sleep pins and/or the wake-up pins, and receives the detection signals output by the linear Hall chip matrix.

In some embodiments, the control system supports a signal output mode and the interrupt wake-up mode. The signal output mode includes the high-speed row-by-row scanning mode, the high-speed interlaced row scanning mode, and the medium-speed scanning mode.

The high-speed row-by-row scanning mode refers to a signal output mode in which the magnetic field detection function of all chips operates continuously, and row-column switching is achieved only through dynamic enabling of the wake-up pins.

For example, in the high-speed row-by-row scanning mode, switching time for each row of linear Hall chips is 15-60 μs, and a sampling period is 120-480 μs.

In some embodiments, in the high-speed row-by-row scanning mode, the main control unit sequentially activates the linear Hall chips of the target row, enabling the linear Hall chips of the target row to enter the operation state for magnetic field detection, while the linear Hall chips of the remaining rows maintain the sleep state. After the linear Hall chips of the target row complete detection, the linear Hall chips of the target row re-enter the sleep state, and the linear Hall chips of a next target row are activated, thereby achieving high-speed row-by-row scanning by cycling.

In some embodiments, the main control unit triggers exiting a low power consumption mode and activates the linear Hall chips of the target row by configuring a logic combination of a low level for the sleep pins and a high level for the wake-up pins of the linear Hall chips of the target row.

The next target row refers to a subsequent row that takes over a scanning detection task from the target row.

In some embodiments, the high-speed row-by-row scanning mode specifically includes: the main control unit enabling all the linear Hall chips to enter the operation state by controlling states of all the sleep pins; the main control unit sequentially configuring a logic control signal for the wake-up pins of the target row, enabling the linear Hall chips of the target row to output the detection signals to the main control unit through the corresponding signal output pins; after scanning of the linear Hall chips of the target row is completed, the main control unit sequentially activating the linear Hall chips of the next target row, thereby achieving high-speed row-by-row scanning and signal acquisition of the linear Hall chip matrix by cycling.

Specifically, in the high-speed row-by-row scanning mode, the main control unit enables all the linear Hall chips to be in the normal operation state by configuring the sleep pins of all the linear Hall chips as low levels, and configures the wake-up pins as high levels according to a preset scanning logic to collect data of the linear Hall chips of the target row as needed, so that the linear Hall chips of the target row output signals normally. The preset scanning logic refers to an algorithm and a rule for configuring the wake-up pins.

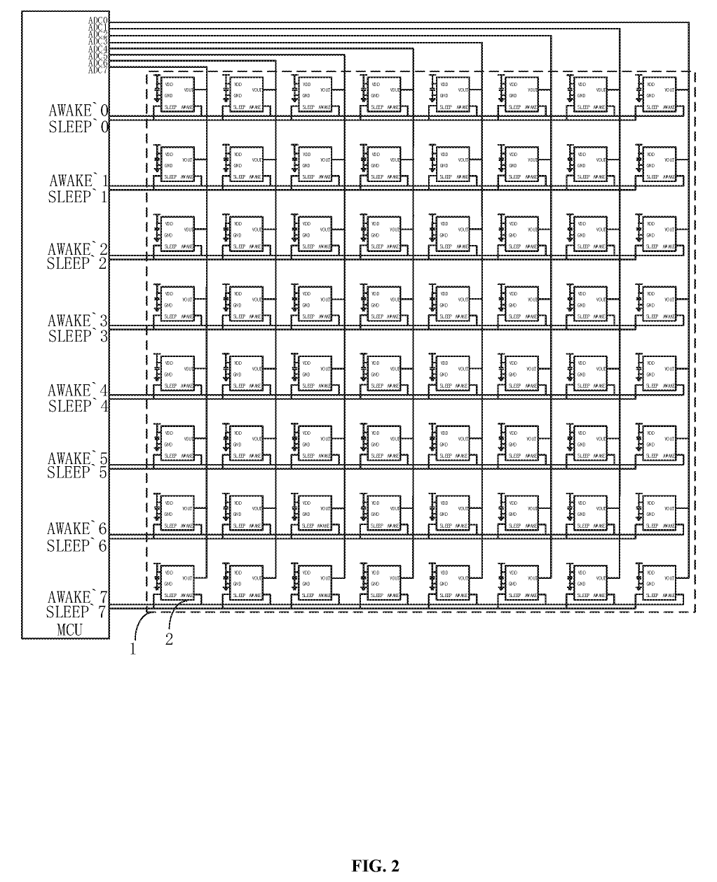

FIG. 2 is a schematic structural diagram of a system for row-column scanning control based on a sleep and wake-up function chip according to some embodiments of the present disclosure.

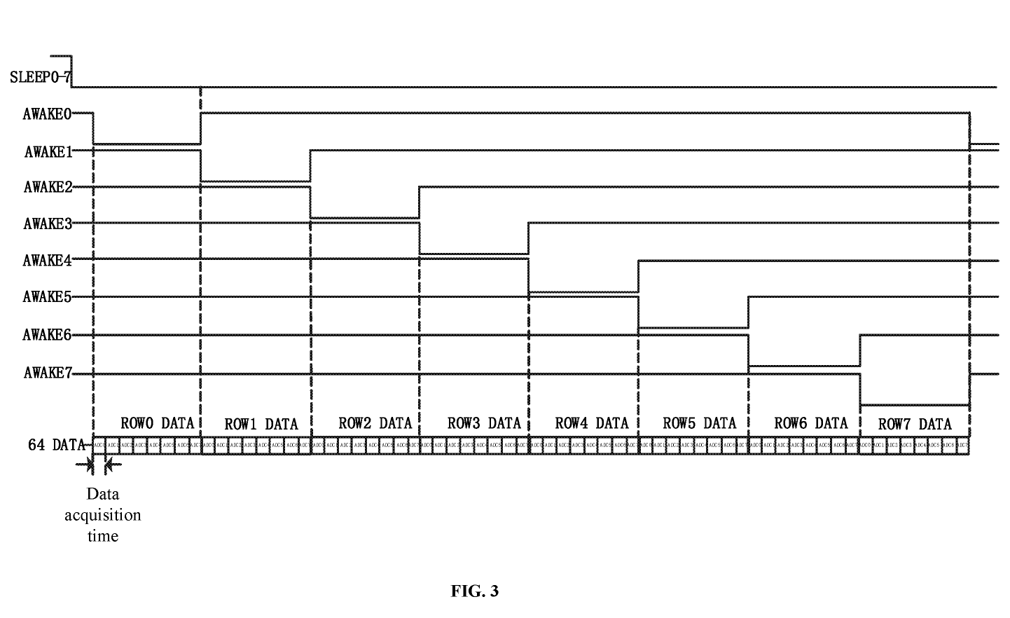

FIG. 3 is a waveform diagram of a system for row-column scanning control based on a sleep and wake-up function chip in a high-speed row-by-row scanning mode according to some embodiments of the present disclosure.

For example, with reference to FIGS. 2 and 3, taking an 8 x 8 linear Hall chip matrix as an example, 8 ports of the main control unit MCU may be provided. When data of a first row of the linear Hall chips needs to be acquired, a wake-up port AWAKE`0 of the main control unit MCU is at a high level, and other wake-up ports AWAKE`1 to AWAKE`7 of the main control unit MCU are at low levels. Correspondingly, the wake-up pins of the first row of the linear Hall chips are at high levels, and the wake-up pins of the linear Hall chips of other rows are at low levels. When data of a second row of the linear Hall chips needs to be collected, the wake-up port AWAKE`1 of the main control unit is at a high level, and other wake-up ports AWAKE`0, AWAKE`2 to AWAKE`7 of the main control unit MCU are at low levels. Correspondingly, the wake-up pins of the second row of the linear Hall chips are at high levels, and the wake-up pins of the linear Hall chips of other rows are at low levels. In this way, the main control unit can selectively control the linear Hall chips of the target row to output signals, while the linear Hall chips of the non-target rows enter a sleep mode, retaining only necessary operation modules, which greatly reduces unnecessary energy consumption. Meanwhile, the main control unit reduces unnecessary data reading and processing, thereby reducing the overall power consumption of the system.

In some embodiments of the present disclosure, by uniformly configuring all the sleep pins to keep all matrix chips continuously operating and relying on dynamic enabling of the wake-up pins to achieve row-by-row high-speed scanning, scanning speed and real-time response capability are improved. There is no need to repeatedly perform the power establishment process from sleep to operation row by row. The row switching delay is compressed from tens of microseconds in traditional solutions to the microsecond level. Combined with the clock edge synchronous triggering mechanism, a refresh rate of tens of kilohertz can be achieved, thereby meeting the stringent requirements for high-speed signal tracking in scenarios such as gaming keyboards and industrial automation.

The high-speed interlaced row scanning mode refers to a signal output mode in which the sleep pins of the current target row and the next target row are at operation levels, and the sleep pins of the remaining rows maintain the sleep state.

For example, in the high-speed interlaced row scanning mode, the switching time for one row of the linear Hall chips is 1-10 μs, and the sampling period is 8-80 μs.

In some embodiments, in the high-speed interlaced row scanning mode, the main control unit simultaneously activates a plurality of rows of the linear Hall chips based on a preset logic, enabling the plurality of rows of the linear Hall chips to synchronously enter the operation state. The main control unit sequentially acquires detection signals of a current target row, while the linear Hall chips of the next target row are already in the pending acquisition state, thereby achieving interlaced row high-speed scanning by cycling.

The preset logic may include simultaneously activating the plurality of rows of the linear Hall chips (e.g., 2 rows), and the next target row entering the operation state in advance (e.g., 30 μs ahead of time) before the current row sampling ends, etc.

The current target row refers to a row in the linear Hall chip matrix that is currently transmitting detection signals to the main control unit within a current scanning period.

The pending acquisition state refers to a state in which, during acquisition of the current target row, the sleep pins of the next target row have been configured with a low-level signal, and the wake-up pins maintain the low-level signal.

In some embodiments, the main control unit enables the linear Hall chips of n adjacent rows in the linear Hall chip matrix to be in the operation state by configuring states of the sleep pins of a plurality of rows, while the linear Hall chips of the remaining rows maintain the sleep state. According to a preset scanning sequence, the main control unit sequentially configures a logic control signal for the wake-up pins of the current target row, enabling the linear Hall chips of the current target row to output the detection signals to the main control unit through the corresponding signal output pins. While the linear Hall chips of the current target row are performing data acquisition, the linear Hall chips of the next target row are in the pending acquisition state to reduce delay during row switching. After scanning of the linear Hall chips of the n adjacent rows is completed, the main control unit controls the linear Hall chips of the current n adjacent rows to re-enter the sleep state and activates the linear Hall chips of a next set of n adjacent rows, thereby achieving interlaced row high-speed scanning by cycling.

It is understood that in the high-speed row-by-row scanning mode, when the main control unit needs to acquire data of the linear Hall chips of the target row, the main control unit only controls the linear Hall chips of the current target row to be in the normal operation state and does not control the linear Hall chips of n rows adjacent to the current target row to be in the normal operation state. In the high-speed interlaced row scanning mode, the main control unit may control a plurality of rows of linear Hall chips to be in the operation state simultaneously. In response to a need to acquire data of linear Hall chips of the target row, the main control unit activates normal output of signals of the linear Hall chips of the current target row accordingly, and controls the linear Hall chips of the next target row to be in the pending acquisition state. The pending acquisition state refers to a state in which the sleep pin is configured as a low level and the wake-up pin maintains the low level. It is understood that, if the linear Hall chip is in the pending acquisition state, the linear Hall chip is in a fast-to-activate state where an internal detection circuit of the linear Hall chip is powered on and operates stably, and the detection signal may be output immediately in response to a level jump of the wake-up pin.

The n rows adjacent to the current target row refer to n-1 subsequent rows that are consecutive in a row number sequence with the current target row in the high-speed interlaced row scanning mode.

In some embodiments, the main control unit configures the sleep pins to enable the linear Hall chips of the n rows adjacent to the current row in the linear Hall chip matrix to be in the operation state, wherein n is any positive integer greater than or equal to 2.

The preset scanning sequence refers to a mathematical recurrence relationship for switching from the current target row to the next target row in the high-speed row-by-row scanning mode.

In some embodiments, the preset scanning sequence may be preset by a technician based on experience.

The scanning being completed refers to a state in which magnetic field detection signal acquisition of the linear Hall chip matrix of the current target row is completed and the magnetic field detection signal is successfully read into a data buffer (e.g., a storage device).

In some embodiments, in response to confirming that the detection signals of the target row are effectively acquired and data is correct, the main control unit configures the wake-up pins of the target row to an invalid level (low level) to exit the operation state, i.e., determines that scanning of the row is completed and switches to a next row.

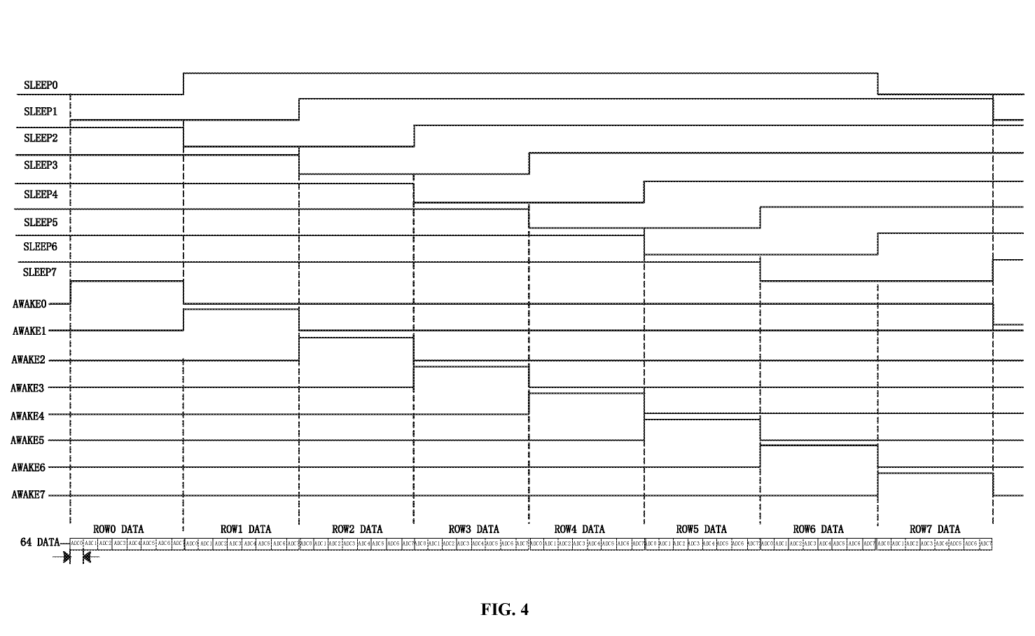

FIG. 4 is a waveform diagram of a system for row-column scanning control based on a sleep and wake-up function chip in a high-speed interlaced row scanning mode according to some embodiments of the present disclosure.

With reference to FIGS. 2 and 4, description continues using an 8 × 8 linear Hall chip matrix and two-row interlaced scanning as an example. In the high-speed interlaced row scanning mode, the main control unit (MCU) controls sleep ports SLEEP`0-SLEEP`7 to implement two-row interlaced scanning. The main control unit controls the linear Hall chips of two rows to be in the operation state, controls the linear Hall chips of other rows to be in the sleep state, and controls output of the linear Hall chips of each row through the wake-up ports AWAKE`0-AWAKE`7.

For example, in response to a need to acquire data of a first row, the main control unit configures sleep ports SLEEP`0 and SLEEP`1 to a low level, configures the output of a wake-up port AWAKE`0 to a high level, and maintains the output of remaining wake-up ports AWAKE`1-AWAKE`7 at the low level. At this time, since the sleep port SLEEP`1 is at the low level, the linear Hall chips of the corresponding row are in the pending acquisition state. In response to a need to acquire data of a second row, the main control unit configures sleep ports SLEEP`1 and SLEEP`2 to the low level, configures the output of a wake-up port AWAKE`1 to the high level, and maintains the output of the linear Hall chips of the remaining rows at the low level. Similarly, at this time, since the sleep port SLEEP`2 is at the low level, the linear Hall chips of the corresponding row are in the pending acquisition state.

When the main control unit acquires data of the linear Hall chips of the current row, the linear Hall chips of a next row are in the operation state, at this time, the main control unit may directly switch on or off the output of the linear Hall chips of the next row merely by controlling the wake-up pin AWAKE of the linear Hall chips of the next row. Accordingly, sampling may be performed without waiting after row scanning switching, greatly improving the scanning speed of the system. Therefore, compared with the high-speed row-by-row scanning mode, the scanning speed of the system in the high-speed interlaced row scanning mode of the present embodiment is faster, and power consumption is lower. As such, compared with the high-speed row-by-row scanning mode, the scanning speed of the system in the high-speed interlaced row scanning mode of the present embodiment is faster.

In some embodiments of the present disclosure, the mechanism of multi-row collaborative scanning balances speed, efficiency, and power consumption during system scanning, fundamentally eliminates waiting intervals in traditional row-by-row scanning, and optimizes the process of row switching to seamless connection, thereby significantly improving the overall scanning rate, and meeting stringent real-time requirements for high-speed signal tracking. The mechanism of multi-row collaborative scanning greatly simplifies control logic. The main control unit can implement matrix traversal merely through single-row pin selection, without needing to equip each row with an independent power switch or complex control circuit, which effectively reduces system complexity and hardware cost, reduces occupation of input/output resources of the microcontroller, and makes the overall architecture more concise and compact.

The medium-speed scanning mode refers to a signal output mode in which only the sleep pins of the target row are at an operation level, and the sleep pins of the remaining rows maintain the sleep state.

For example, the switching time for one row of the linear Hall chips in the medium-speed scanning mode is 15-60 μs, and the sampling period is 0.9-80 ms.

In some embodiments, in the medium-speed scanning mode, the main control unit controls the linear Hall chips of the target row to maintain the operation state, controls the linear Hall chips of the remaining rows to maintain the sleep state, thereby achieving medium-speed scanning by cycling.

The remaining rows refer to rows of the linear Hall chip matrix other than the target row.

In some embodiments, the medium-speed scanning mode is applicable to a power consumption sensitive scenario. The main control unit controls the states of the sleep pins of the target row to enable the linear Hall chips of the target row to be in the operation state, and controls the linear Hall chips of the remaining rows to maintain the sleep state. The linear Hall chips of the target row detect an external magnetic field variation, and transmit the detection signals to the main control unit through corresponding signal output pins. In response to completion of data acquisition of the linear Hall chips of the target row, the main control unit selects to maintain the linear Hall chips of the target row to continue operating or enable the linear Hall chips of the target row to re-enter the sleep state based on system requirements.

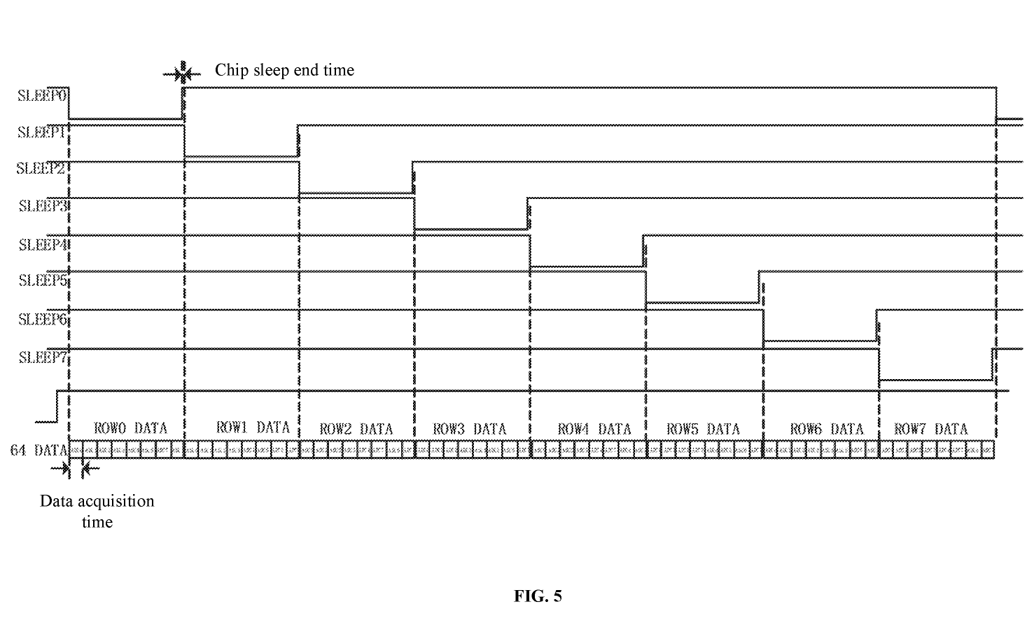

FIG. 5 is a waveform diagram of a system for row-column scanning control based on a sleep and wake-up function chip in a medium-speed scanning mode according to some embodiments of the present disclosure.

With reference to FIGS. 2 and 5, when chips of a target row for data acquisition by a main control unit are chips of a first row, the main control unit configures a sleep port SLEEP`0 to a low level and configures sleep ports SLEEP`1 to SLEEP`7 to a high level. Alternatively, when chips of a target row for data acquisition by the main control unit are chips of a second row, the main control unit configures a sleep port SLEEP`1 to the low level and configures a sleep port SLEEP`0 and sleep ports SLEEP`2 to SLEEP`7 to the high level. As such, switching sequentially may complete data acquisition of chips of all rows. Using the medium-speed scanning mode achieves lower power consumption compared with using the high-speed row-by-row scanning mode and the high-speed interlaced row scanning mode described above.

The power consumption sensitive scenario refers to an application environment with strict constraints on energy efficiency.

For example, the power consumption sensitive scenario includes a wireless three-mode keyboard, an industrial Internet of Things magnetic sensor node, an automotive wireless tire pressure monitoring magnetic sensor, etc.

The system requirements refer to quantitative indicators and functional constraints imposed on the system for scanning control by an application scenario.

In some embodiments, the main control unit may determine the system requirements based on the power consumption sensitive scenario by querying a preset table. The preset table may include a relationship between the power consumption sensitive scenario and the system requirements. In some embodiments, the preset table may be preset by a technician based on experience.

In some embodiments of the present disclosure, the collaborative control mechanism of single-row activation and dynamic retention in the medium-speed scanning mode significantly optimizes energy consumption performance of the system. By enabling the chips of the non-target rows to be in the sleep state and maintaining only the chips of the target row in the operation state, average power consumption of the system is greatly reduced, thereby effectively extending the battery life of a battery-powered device and reducing the frequency of charging or battery replacement. The main control unit can autonomously select to maintain the target row to continue operating or enable the target row to re-enter the sleep state based on real-time task requirements, achieving smooth transition from continuous monitoring to low power consumption standby.

In some embodiments, the main control unit includes a plurality of sets of ports. Each set of the plurality of sets of ports includes the sleep ports respectively connected to the sleep pins of the linear Hall chips of each row; and the wake-up ports respectively connected to the wake-up pins of the linear Hall chips of each row.

The port refers to a hardware interface circuit for implementing electrical connection and signal interaction between the main control unit and the linear Hall chip matrix.

The sleep port SLEEP` is respectively connected to sleep pins SLEEP of the linear Hall chips of each row.

The wake-up port AWAKE` is respectively connected to wake-up pins AWAKE of the linear Hall chips of each row.

In some embodiments, the main control unit and the linear Hall chips of each row are connected through respective sleep ports SLEEP` and sleep pins SLEEP, such that the main control unit transmits a sleep signal to the linear Hall chips of each row to control the chips to switch between the operation state and the sleep state. The main control unit and the linear Hall chips of each row are connected through respective wake-up ports AWAKE` and wake-up pins AWAKE, such that the main control unit transmits a logic control signal to the linear Hall chips of each row to manage the chips to switch between a normal output state and a high-impedance state.

In addition, it should be noted that a count of the plurality of sets of ports of the main control unit matches a chip matrix structure.

In some embodiments of the present disclosure, the port architecture implements refined row-level power consumption management and dynamic timing control by configuring an independent sleep and wake-up control channel for each row of chips.

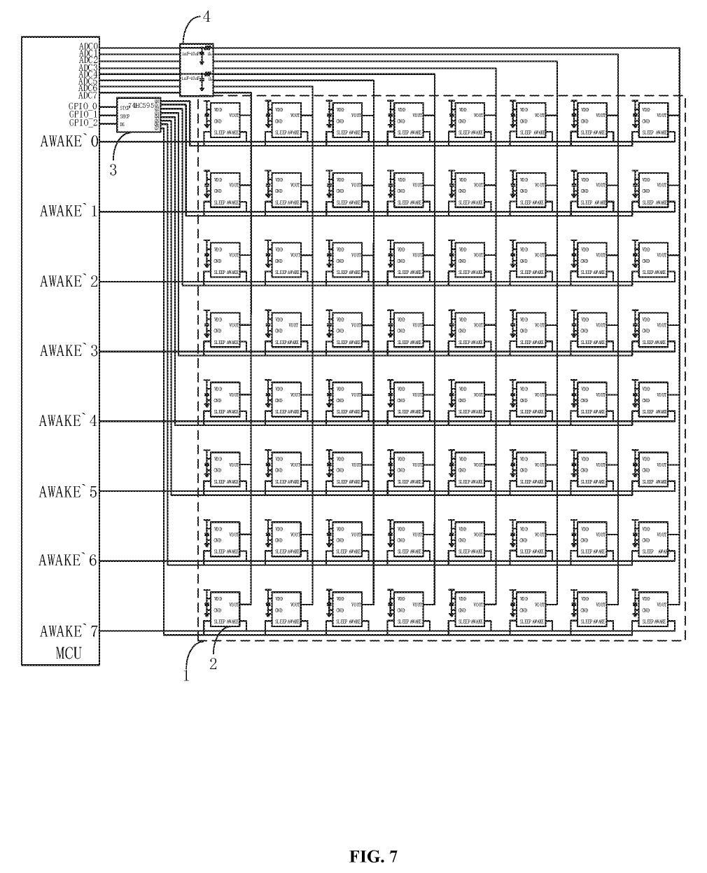

FIG. 7 is a schematic structural diagram of a system for row-column scanning control based on a sleep and wake-up function chip according to some embodiments of the present disclosure.

In some embodiments, with reference to FIG. 7, the main control unit further includes a plurality of sampling ports. A count of the plurality of sampling ports matches a structure of the linear Hall chip matrix, i.e., ADC0 to ADC7 in the figure. In an occasion with relatively high noise requirements and relatively low sampling speed, the system for row-column scanning control further includes an RC low-pass filter module 4. The RC low-pass filter module is connected between an output terminal of each of the linear Hall chips and the plurality of sampling ports, and is configured to filter high-frequency noise in a signal to improve sampling accuracy of the sampling ports of the main control unit.

The RC low-pass filter module refers to a network module that allows low-frequency signals to pass through while attenuating high-frequency components.

In some embodiments, the RC low-pass filter module may be configured to filter high-frequency noise in the signal.

In some embodiments, an RC value of the RC low-pass filter module may be set by a technician based on requirements.

In some embodiments, the system further includes a shift register configured to implement row-by-row dynamic control through serial communication. The shift register is provided with a plurality of serial communication input ports and register output ports. The main control unit is provided with a plurality of serial communication output ports and wake-up ports. Each of the serial communication input ports is connected one-to-one to a corresponding serial communication output port of the main control unit. Each of the register output ports is connected one-to-one to the sleep pin of a corresponding row of the linear Hall chips. Each of the wake-up ports is connected one-to-one to the wake-up pin of a corresponding row of the linear Hall chips.

The shift register refers to a component configured to implement row-by-row dynamic control through serial communication.

In some embodiments, the shift register receives a control signal from the main control unit and switches the operation state of the linear Hall chips row by row, activates the linear Hall chips of the target row, and controls the linear Hall chips of other rows to maintain the sleep state.

The serial communication refers to a communication mode of sending sleep/wake-up control instructions to the shift register bit by bit through a small number of signal lines.

The serial communication input port refers to a three-channel digital input interface on the shift register for receiving a serial sleep signal from the main control unit. The serial sleep signal refers to a signal that enables the linear Hall chip to enter the sleep state in a bit-by-bit serial manner.

The register output port refers to a multi-bit (e.g., 8-bit) parallel output interface for driving sleep pins of each row of the linear Hall chip matrix.

The serial communication output port refers to a three-channel general purpose input/output (GPIO) interface for sending a control instruction to the shift register.

The wake-up port refers to a multi-channel push-pull output interface for independently controlling a signal output state of each row of linear Hall chips.

In some embodiments, the main control unit activates the signal output of the linear Hall chips of the target row or receives an interrupt signal through the wake-up ports.

Merely by way of example, continuing using an 8 × 8 linear Hall chip matrix as an example, the plurality of serial communication input ports include a data input port DS, a clock input port SHCP, and a latch input port STCP. The plurality of register output ports include eight register output ports Q0-Q7. Correspondingly, the plurality of serial communication output ports include three serial communication ports GPIO_0-GPIO_2. The plurality of wake-up ports include eight wake-up ports AWAKE`0-AWAKE`7. The data input port DS of the shift register is configured to receive a serial sleep signal from the main control unit. The clock input port SHCP is configured to receive a clock signal provided by the main control unit. The latch input port STCP is configured to receive a latch signal from the main control unit. The main control unit sends the sleep signal bit by bit to the shift register through the data input port DS. The sleep signal is shifted into the register under control of the clock signal. After shifting of the sleep signal is completed, the latch input port STCP latches the sleep signal to the register output ports based on the latch signal.

In some embodiments of the present disclosure, by providing the shift register to communicate with the main control unit, a plurality of outputs can be controlled with only a small number of ports, thereby saving port resources of the main control unit. Meanwhile, the shift register supports high-speed serial data transmission, effectively improving data transmission efficiency between the main control unit and the linear Hall chip matrix.

In some embodiments of the present disclosure, by constructing a three-dimensional collaborative control architecture of sleep pin-wake-up pin-signal output pin and a row-column bus short-circuit topology, the main control unit independently configures the sleep pins of the chips of each row, causing the chips of the non-target rows to enter a μA-level sleep state, thereby significantly reducing energy consumption. Dynamic switching among the high-speed row-by-row scanning mode, the high-speed interlaced row scanning mode, and the medium-speed scanning mode can be achieved through logic combination configuration, adapting to diverse scenarios from gaming keyboards (12.5 kHz refresh rate) to power consumption sensitive sensors (1 kHz refresh rate). Meanwhile, bus signal conflicts are avoided, the signal-to-noise ratio is improved, and the false trigger rate is reduced.

The foregoing descriptions are merely preferred embodiments of the present disclosure and are not intended to limit the present disclosure. Any modifications, equivalent replacements, improvements, etc., made within the spirit and principles of the present disclosure shall be included within the protection scope of the present disclosure.

What is claimed is:

1. A system for row-column scanning control based on a sleep and wake-up function chip, comprising:
a linear Hall chip matrix including a plurality of linear Hall chips arranged in a matrix structure of N rows × M columns, wherein each of the plurality of linear Hall chips includes:
a sleep pin configured to receive a sleep signal to control an operation state of the linear Hall chip and switch the linear Hall chip to a sleep state;
a wake-up pin configured to receive a logic control signal to manage an output state of the linear Hall chip, or output an interrupt signal in the sleep state to trigger system wake-up; and
a signal output pin configured to output a detection signal; and
a main control unit, wherein the main control unit is connected to the sleep pins and the wake-up pins of each row of the linear Hall chips;
wherein the main control unit includes at least: M sets of acquisition input ports corresponding to M columns of the linear Hall chip matrix, respectively; wherein
the signal output pins of each column of the linear Hall chips are short-circuited and correspondingly connected to a set of acquisition input ports of the main control unit;
the main control unit controls the system to enter a high-speed row-by-row scanning mode, a high-speed interlaced row scanning mode, or a medium-speed scanning mode by configuring a logic combination of the sleep pins and/or the wake-up pins, and receives the detection signal output by the linear Hall chip matrix; and
the system is operable in different scanning modes, and the operation state of the linear Hall chip matrix is controlled by the main control unit, wherein
in the high-speed row-by-row scanning mode, the main control unit activates linear Hall chips of a target row in sequence to enter the operation state for magnetic field detection, and linear Hall chips of remaining rows maintain the sleep state; when the linear Hall chips of the target row complete detection, the linear Hall chips of the target row re-enter the sleep state, and linear Hall chips of a next target row are activated, thereby achieving high-speed row-by-row scanning by cycling;
in the high-speed interlaced row scanning mode, the main control unit simultaneously activates a plurality of rows of linear Hall chips based on a preset logic to synchronously enter the operation state; the main control unit acquires detection signals of a current target row in sequence, while the linear Hall chips of the next target row are already in a pending acquisition state, thereby achieving interlaced row high-speed scanning by cycling;
in the medium-speed scanning mode, the main control unit controls the linear Hall chips of the target row to maintain the operation state, and the linear Hall chips of the remaining rows maintain the sleep state, thereby achieving medium-speed scanning by cycling; or
in the sleep state, if any of the linear Hall chips detects an external magnetic field variation, the interrupt signal is output to the main control unit through the wake-up pin to trigger system wake-up.

2. The system according to claim 1, wherein the operation state of the linear Hall chip is controlled by the main control unit, and state switching is performed through the sleep pin and the wake-up pin to manage signal output of the linear Hall chip, wherein:
the sleep state: when the main control unit sends the sleep signal to the linear Hall chips of the target row, the linear Hall chips of the target row enter the sleep state, stop normal signal output, and the signal output pin is in a high-impedance state;
the operation state: when the main control unit sends a wake-up signal to the linear Hall chips of the target row, the linear Hall chips of the target row exit the sleep state and enter the operation state, start detecting the external magnetic field variation, and send the detection signals through the corresponding signal output pins; and
the main control unit achieves row-by-row scanning by dynamically controlling the sleep pins and the wake-up pins of each row of the linear Hall chips, enabling the linear Hall chips of the target row to be in the operation state, while the linear Hall chips of the remaining rows maintain the sleep state or the high-impedance state.

3. The system according to claim 1, wherein:
the main control unit sends the sleep signal to all the linear Hall chips and enters the sleep state, retaining only an interrupt wake-up function; and all the linear Hall chips switch to a low power consumption mode and independently detect the external magnetic field variation; and
when any of the linear Hall chips detects that the external magnetic field variation exceeds a set threshold, the linear Hall chip outputs the interrupt signal to the main control unit; and after receiving the interrupt signal, the main control unit switches from the sleep state to the operation state.

4. The system according to claim 1, wherein the high-speed row-by-row scanning mode includes:
the main control unit enabling all the linear Hall chips to enter the operation state by controlling states of all the sleep pins;
the main control unit configuring the logic control signal for the wake-up pins of the target row in sequence, enabling the linear Hall chips of the target row to output the detection signal to the main control unit through the corresponding signal output pin;
after scanning of the linear Hall chips of the target row is completed, the linear Hall chips of the next target row being activated in sequence, thereby achieving high-speed row-by-row scanning and signal acquisition of the linear Hall chip matrix by cycling.

5. The system according to claim 1, wherein the high-speed interlaced row scanning mode includes:
the main control unit configuring states of a plurality of rows of sleep pins, enabling the linear Hall chips of n adjacent rows in the linear Hall chip matrix to be in the operation state and the linear Hall chips of remaining rows to maintain the sleep state;
the main control unit configuring the logic control signal for the wake-up pins of the current target row in sequence based on a preset scanning sequence, enabling the linear Hall chips of the current target row to output the detection signal to the main control unit through the corresponding signal output pin;
when the linear Hall chips of the current target row perform data acquisition, the linear Hall chips of the next target row being in the pending acquisition state to reduce delay during row switching; and
when scanning of the linear Hall chips of the n adjacent rows is completed, the main control unit controlling the linear Hall chips of the current n adjacent rows to re-enter the sleep state and activating the linear Hall chips of a next set of n adjacent rows, thereby achieving interlaced row high-speed scanning by cycling.

6. The system according to claim 1, wherein the medium-speed scanning mode is applicable to a power consumption sensitive scenario, including:
the main control unit controlling states of the sleep pins of the target row, enabling the linear Hall chips of the target row to be in the operation state, and the linear Hall chips of the remaining rows to maintain the sleep state;
the linear Hall chips of the target row detecting the external magnetic field variation and transmitting the detection signal to the main control unit through the corresponding signal output pin; and
after data acquisition of the linear Hall chips of the target row is completed, the main control unit selecting, based on a system requirement, to keep the linear Hall chips of the target row continuing to work, or to cause the linear Hall chips of the target row to re-enter the sleep state.

7. The system according to claim 1, wherein the main control unit includes a plurality of sets of ports, and each set of ports includes:
a sleep port connected to the sleep pins of each row of the linear Hall chips; and
a wake-up port connected to the wake-up pins of each row of the linear Hall chips.

8. The system according to claim 1, further comprising a shift register which achieves row-by-row dynamic control through serial communication; wherein
the shift register is provided with a plurality of serial communication input ports and register output ports;
the main control unit is provided with a plurality of serial communication output ports and wake-up ports; and
each of the serial communication input ports is one-to-one connected to each of the serial communication output ports of the main control unit; each of the register output ports is one-to-one connected to each sleep pin of each row of the linear Hall chips; and each of the wake-up ports is one-to-one connected to each wake-up pin of each row of the linear Hall chips.

9. The system according to claim 1, wherein the detection signal of the linear Hall chip supports analog voltage output or digital signal output to adapt to requirements of different data acquisition devices.

10. The system according to claim 1, wherein the logic control signal includes one of a level signal, a level inversion signal, a pulse signal, a timing control signal, or a data carrier signal.

11. The system according to claim 1, wherein the linear Hall chip matrix adopts dynamic N × M arrangement, N and M being any positive integers, to adapt to different signal acquisition requirements.

12. The system according to claim 5, wherein the main control unit configures the sleep pin to cause the linear Hall chips of the n adjacent rows in the linear Hall chip matrix to be in the operation state, wherein n is any positive integer greater than or equal to 2.

13. The system according to claim 3, wherein the main control unit controls a plurality of linear Hall chip matrices through a clock signal to achieve synchronous signal acquisition.
